(19) United States
(12) Patent Application Publication
(10) Pub. No.: US 2021/0347124 A1
(43) Pub. Date: Nov. 11, 2021

(54) 3D PRINTED PACKAGE MATERIAL SELECTION BASED UPON FORECAST EXPOSURE AT DELIVERY LOCATION

(71) Applicant: INTERNATIONAL BUSINESS MACHINES CORPORATION, Armonk, NY (US)

(72) Inventors: Craig M. Trim, Ventura, CA (US); Michael Bender, Rye Brook, NY (US); Jeremy R. Fox, Georgetown, TX (US); Martin G. Keen, Cary, NC (US)

(21) Appl. No.: 16/867,599

(22) Filed: May 6, 2020

(51) Int. Cl. B29C 64/393; G06Q 10/08; G01W 1/12; G01W 1/14; G06N 3/08

(52) U.S. Cl. CPC B29C 64/393; G06Q 10/0832; G06N 3/08; G01W 1/12; G01W 1/14; G06Q 10/0833

(57) ABSTRACT

A method, computer system, and computer program product for optional material selection for 3D printed package are provided. The embodiment may include deriving a delivery window of a shipping package from a delivery provider. The embodiment may also include deriving an expected package outdoor exposure at a delivery destination. The embodiment may further include deriving an expected exposure duration. The embodiment may also include retrieving weather forecast for the derived delivery window, the derived package outdoor exposure and the derived exposure duration. The embodiment may further include generating a forecast precipitation exposure, a forecast UV exposure and a forecast temperature exposure based on the retrieved weather forecast. The embodiment may also include scoring a 3D packaging material suitability for each packaging material. The embodiment may further include generating an optimal material recommendation based on the scoring of the 3D packaging material suitability for each packing material.

### BACKGROUND

The present invention relates, generally, to the field of computing, and more particularly to a selection of material to be used in 3D printing packaging.

3D printing is a way of creating three dimensional solid objects. 3D printing is done by building up the object layer by layer. One way that 3D printing may be used is to create on-demand packaging. 3D printing may promote special or time-sensitive sales opportunities including a special short-term event or pop-up or significant sport or cultural event or celebrations. 3D printing may also allow each customer to personalize the packaging based on a personalized design option or materials used to produce the packaging. It may include changing the label on a product but also includes actual modifications of actual packaging material, design, size, shape, and structures.

### SUMMARY

According to one embodiment, a method, computer system, and computer program product for optional material selection for 3D printed packages are provided. The embodiment may include deriving a delivery window of a shipping package from a delivery provider. The embodiment may also include deriving an expected outdoor exposure at a delivery destination. The embodiment may further include deriving an expected exposure duration. The embodiment may also include retrieving weather forecast for the derived delivery window, the derived package outdoor exposure, and the derived exposure duration. The embodiment may further include generating a forecast precipitation exposure, a forecast UV exposure, and a forecast temperature exposure based on the retrieved weather forecast. The embodiment may also include scoring a 3D packaging material suitability for each packaging material. The embodiment may further include generating an optimal material recommendation based on the scoring of the 3D packaging material suitability for each packing material.

### BRIEF DESCRIPTION OF THE SEVERAL VIEWS OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a 3D printed package material selection process according to at least one embodiment;

FIG. 3 is an exemplary diagram depicting a package delivery exposure location deriving process according to at least one embodiment:

FIG. 4 is an exemplary diagram depicting a package delivery exposure duration deriving process according to at least one embodiment:

FIG. 5 is an exemplary diagram depicting a 3D printing material suitability scoring and optimal material recommendation process according to at least one embodiment:

FIG. 6 is a block diagram of internal and external components of computers and servers depicted in FIG. 1 according to at least one embodiment;

FIG. 7 depicts a cloud computing environment according to an embodiment of the present invention; and

FIG. 8 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to 3D printed packaging systems. The following described exemplary embodiments provide a system, method, and program product to select material to be used for 3D printing packaging based on the weather forecast exposure to precipitation, UV and temperature that the packaging may be subjected to at the delivery location. Therefore, the present embodiment has the capacity to improve the technical field of 3D printing packaging systems by recommending an optimal material to be used based upon the above weather forecasts.

As previously described, 3D printing is a way of creating three dimensional solid objects. 3D printing is done by building up the object layer by layer. One way that 3D printing may be used is to create on-demand packaging. 3D printing may promote special or time-sensitive sales opportunities including a special short-term event or pop-up or significant sport or cultural event or celebrations. 3D printing may also allow each customer to personalize the packaging based on a personalized design option or materials used to produce the packaging. It may include changing the label on a product but also includes actual modifications of actual packaging material, design, size, shape, and structures.

3D printing has been increasingly adopted for packaging needs. One benefit of 3D printing is customization. A customer may select attributes such as colors and shapes to be printed separately. When selecting materials with which to build 3D packaging, there may be many choices. Such materials may include Acrylonitrile Butadiene Styrene, Polylactic Acid, Nylon. Polypropylene, Resin, and Polyethylene Terephthalate. Decisions on which 3D printing material to a use may be typically based on constant known factors such as the cost of materials and, the strength of materials to adequately protect the item packaging is storing. As such, it may be advantageous to, among other things, implement a system capable of dynamically analyzing factors related to package delivery to determine which packaging material is the most suitable for a given package or order. Such factors may include destination forecast weather conditions, destination forecast exposure level, and destination forecast exposure time. Humans may not review all the weather forecasts for every package being sent daily as the limited amount of time available to package theses items would not allow it to happen within a timely fashion. The current invention is making an automated 3D printing package and enables package materials to change dynamically to ensure the best material(s) are used for a parcel being prepared for shipping logistics. Due to the high daily demand for parcel packing, humans may not be expected to correctly make packing decisions repeatably.

According to one embodiment, the present invention may recommend optimal packaging materials for 3D printing of individual packages. In at least one other embodiment, the present invention may also aggregate optimal packaging materials for 3D printing of a batch of packages.

The present invention may be a system, a method, and/or a computer program product at any possible technical detail level of integration. The computer program product may include the computer readable storage medium (or media) having computer readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer-readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or another device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product for determining the suitability of a 3D printing material to creating packaging for a given item based upon destination conditions and anticipated exposure time.

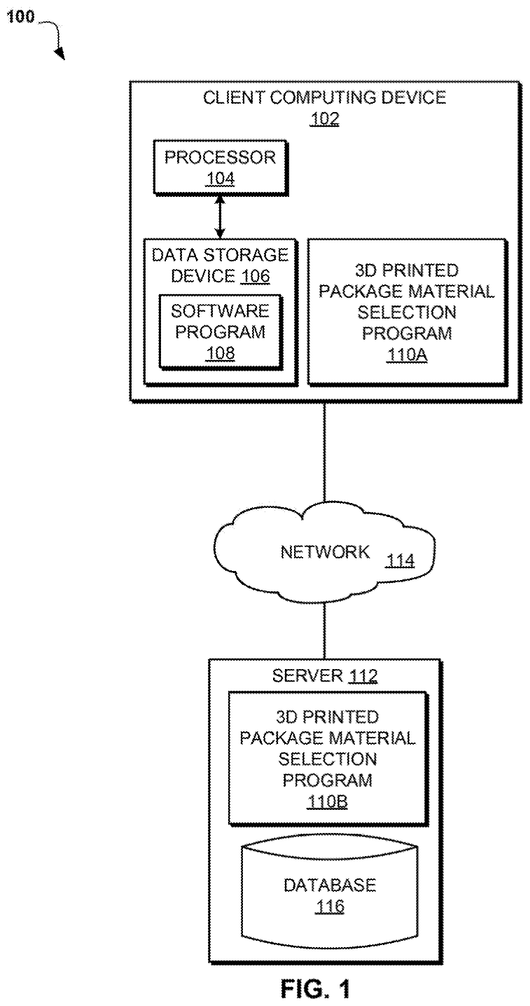

Referring to FIG. 1, an exemplary networked computer environment 100 is depicted according to at least one embodiment. The networked computer environment 100 may include a client computing device 102 and a server 112 interconnected via a communication network 114. According to at least one implementation, the networked computer environment 100 may include a plurality of client computing devices 102 and servers 112 of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

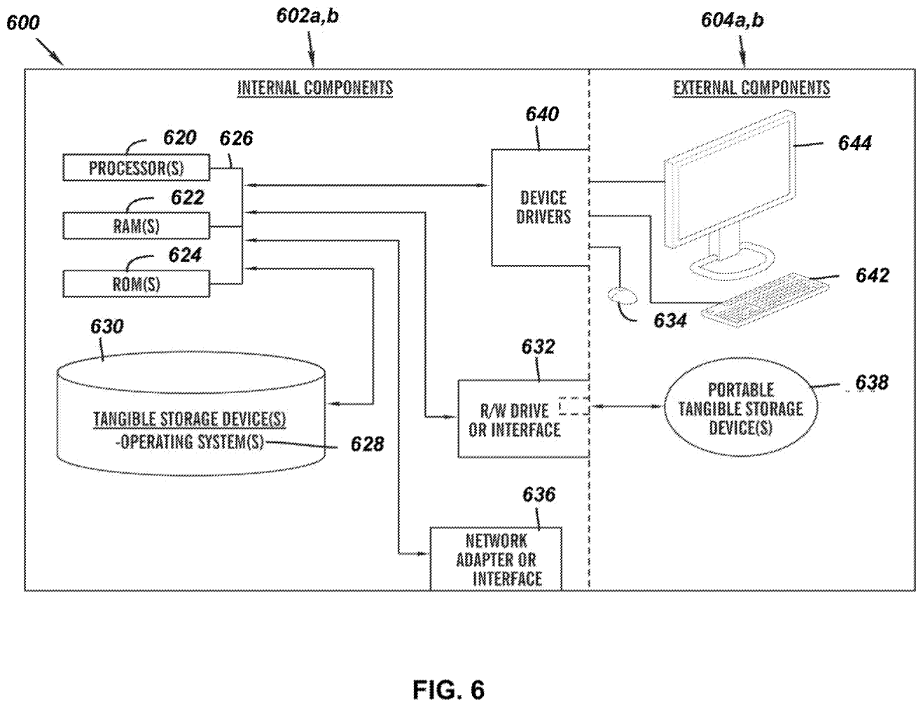

Client computing device 102 may include a processor 104 and a data storage device 106 that is enabled to host and run a software program 108 and a 3D printed package material selection program 110A and communicate with the server 112 via the communication network 114, in accordance with one embodiment of the invention. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 6, the client computing device 102 may include internal components 602a and external components 604a, respectively.

The server computer 112 may be a laptop computer, netbook computer, personal computer (PC), a desktop computer, or any programmable electronic device or any network of programmable electronic devices capable of hosting and running as 3D printed package material selection program 110B and a database 116 and communicating with the client computing device 102 via the communication network 114, in accordance with embodiments of the invention. As will be discussed with reference to FIG. 6, the server computer 112 may include internal components 602b and external components 604b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

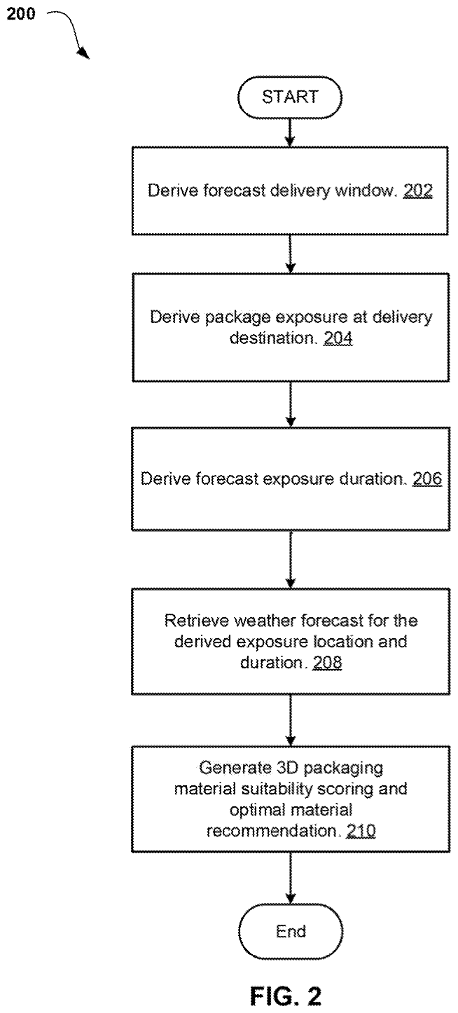

According to the present embodiment, the 3D printed package material selection program 110A, 110B may be a program capable of deriving the forecast precipitation, UV, and temperature that a given package may be exposed to from the time it is delivered to a location to the time it is collected or brought inside from that location. The 3D printed package material selection process is explained in further detail below with respect to FIG. 2.

Referring to FIG. 2, an operational flowchart illustrating a 3D printed package material selection process 200 is depicted according to at least one embodiment. At 202, the 3D printed package material selection program 110A, 110B derives the forecast delivery window. According to one embodiment, the 3D printed package material selection program 110A, 110B may interface with a delivery provider to determine information about the forecast delivery of a given package. For example, if a user orders a package delivery, the 3D printed package material selection program 110A, 110B may retrieve the expected delivery window for the package given a projected shipment date to a given destination. For instance, the delivery provider may provide the information that the delivery is expected to arrive at the destination by a certain day of the week between certain times. In at least one embodiment, the 3D printed package material selection program 110A, 110B may store such delivery information in the database 116 for later determination of appropriate packing material.

At 204, the 3D printed package material selection program 110A, 110B derives package exposure at the delivery destination. According to one embodiment, the 3D printed package material selection program 110A, 110B may derive where the package will be dropped off at the destination to derive the exposure to outdoor elements. In at least one other embodiment, the 3D printed package material selection program 110A, 110B may interface with the delivery provider to determine if the package will be left outdoors. Potential outdoor location at a destination may include an outdoor mailbox, a porch by the front door, or an outdoor step by the front door. The 3D printed package material selection program 110A, 110B may utilize numerous sources to derive package exposure, such as convolutional neural network visual image classification. In at least one other embodiment, the 3D printed package material selection program 110A, 110B may retrieve visual delivery confirmation corpora from a delivery provider. For example, a delivery provider may provide a visual delivery confirmation to the recipient showing where the recipient's package has been delivered. For instance, the 3D printed package material selection program 110A, 110B may retrieve the delivery confirmation photos from the recipient's email or mobile device to determine exactly where in the outdoors the package has been delivered. In one embodiment, the 3D printed package material selection program 110A, 110B may store such information and the pictures in a database to use as a historical corpus of likely delivery locations for a similar package in the future. In yet another embodiment, the 3D printed package material selection program 110A, 110B may utilize known street view mapping technologies to analyze a street view image for a delivery location.

The 3D printed package material selection program 110A, 110B may then utilize a convolutional neural network to classify potential or historical delivery locations and derive exposure factors that pertain to the delivery location of the package. In one embodiment, the 3D printed package material selection program 110A, 110B may determine and analyze factors such as precipitation, UV, or temperature. For example, the 3D printed package material selection program 110A, 110B may determine whether a given package will be affected by rain, snow, or hail or the package is reasonably safe as it may be protected by a porch roof or a mailbox. The temperature may be monitored to determine whether the package is likely to be exposed to hot or cold temperatures to the extent that the temperature may deform the given package. Prolonged exposure to UV at the potential delivery location may be monitored as well.

At 206, the 3D printed package material selection program 110A, 110B derives forecast exposure duration. According to one embodiment, the 3D printed package material selection program 110A, 110B may retrieve the date and time of expected delivery and the exposure at the delivery location to determine how long the package is expected to remain at its location before being collected. In one embodiment, the 3D printed package material selection program 110A, 110B may utilize an IoT security camera that can provide real-time capture of a property. For example, an analysis of a security camera may determine how long a package remains outside before the recipient brings the package inside. In at least one other embodiment, the 3D printed package material selection program 110A, 110B may store a corpus of data showing average times of when packages are brought inside on certain days and at certain times of the day. In yet another embodiment, the 3D printed package material selection program 110A, 110B may utilize mobile devices such as a smartphone or a smartwatch that can indicate the current location of the recipient such that the expected collections time of the package may be determined. For example, analysis of location information retrieved from the recipient's smartphone or smartwatch may determine when the recipient is at work or when the recipient is at home. In at least one other embodiment, the 3D printed package material selection program 110A, 110B may retrieve electronic schedule information such as the recipient's calendar, instant messaging, and emails to analyze when the recipient is likely to return home. For instance, if the recipient is out of town or on a business trip for a few months, the 3D printed package material selection program 110A, 110B may analyze the recipient's schedule information to determine the expected return date of the recipient and correlate such information to the expected collection time of the package.

In yet another embodiment, the 3D printed package material selection program 110A, 110B may generate a confidence level of each of the above described retrieved information. The 3D printed package material selection program 110A, 110B may indicate the strength of the data used to derive the forecast. For instance, based upon the generated confidence level, the 3D printed package material selection program 110A, 110B may calculate an expected exposure time range for the package or the time from expected delivery to expected collection. The time range may be extended for lower confidence predictions. For example, if the 3D printed package material selection program 110A, 110B determines a 90% confidence level, the forecast exposure time maybe 2-3 hours for an expected delivery time, whereas, for a prediction with a 65% confidence level, the forecast exposure time may be 2 to 6 hours, which may be a long hour range as the data with a less confidence level may lead to a less certain prediction.

At 208, the 3D printed package material selection program 110A, 110B retrieves weather forecast for derived exposure location and duration. According to one embodiment, the 3D printed package material selection program 110A, 110B may utilize the derived exposure data and time and expected duration to retrieve a weather forecast for the delivery location that correlates to this period. The 3D printed package material selection program 110A, 110B may retrieve weather forecast for a period of time and take into account one or more different weather forecast where there is uncertainty in the forecast. Based upon the correlation of the weather information to the expected delivery time and the exposure duration, the 3D printed package material selection program 110A, 110B may derive forecast exposure to precipitation during the exposure duration. In one other embodiment, the 3D printed package material selection program 110A, 110B may adjust the likelihood of exposure of a package that may be exposed to precipitation based upon chances of the weather forecast precipitation may change if the 3D printed package material selection program 110A, 110B determines that the package is properly sheltered on a porch which makes it less exposed to precipitation. The 3D printed package material selection program 110A, 110B may also take into account the wind direction and the wind speed to determine whether the properly sheltered package is indeed safe from the forecast precipitation (e.g. snow, rain, hail, etc.). In yet another embodiment, the 3D printed package material selection program 110A, 110B may determine the likelihood of a package exposure to UV. It may be determined based on analysis of the weather forecast for cloud cover combined with the angle of sunlight which may indicate whether the package may be in direct sunlight or shade. The 3D printed package material selection program 110A, 110B may also determine the likely temperature to which the package may be exposed while at the delivery location.

At 210, the 3D printed package material selection program 110A, 110B generates 3D packaging material suitability scoring and optimal material recommendation. According to one embodiment, the 3D printed package material selection program 110A, 110B may recommend a suitable packaging material to be utilized by a 3D printer that is compatible with the derived conditions that a package may be exposed to during the delivery time. In at least one other embodiment, the 3D printed package material selection program 110A, 110B may generate suitability scores for each packaging material and recommend an optimal packaging material for a given package. For example, popular packaging materials may include Acrylonitrile Butadiene Styrene, Polylactic Acid, Nylon. Polypropylene, Resin, and Polyethylene Terephthalate, and the 3D printed package material selection program 110A, 110B may assign a suitability score for each material with a summarization of the reasoning and the retrieved data on which summarization is based. The suitability scores may be based on the forecast exposure time to precipitation, UV, and temperature. In at least one other embodiment, the 3D printed package material selection program 110A, 110B may include a cost analysis for each package such that a user may not only consider the forecast information but also the potential cost associated with the option the user may choose. In some embodiments, the packaging material recommendation may be transmitted to a 3D printer and used by the 3D printer to print one or more packages using the recommended material or materials as part of step 210. The package may be automatically printed or the recommendation may be approved by a user prior to printing.

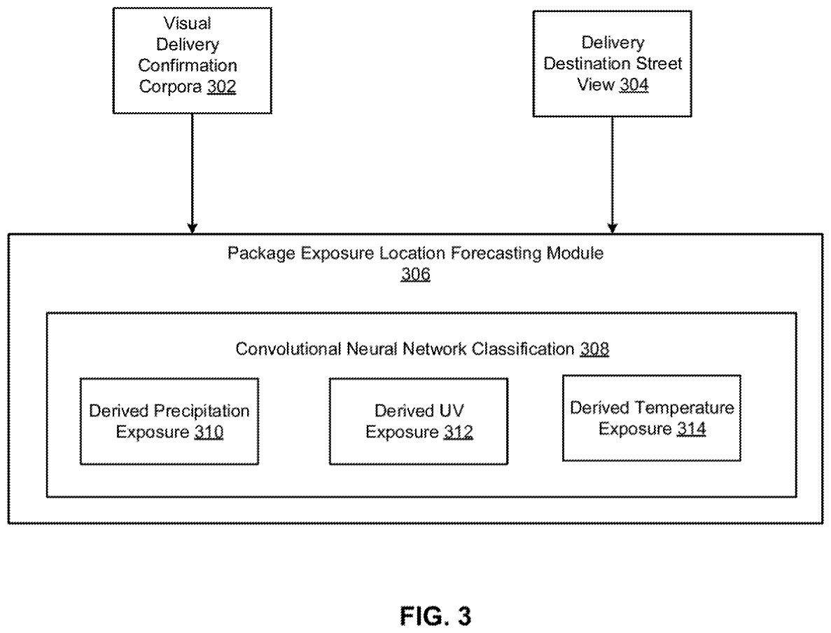

Referring now to FIG. 3, an exemplary diagram showing a package delivery exposure location deriving process is depicted according to at least one embodiment. According to one embodiment, the 3D printed package material selection program 110A, 110B may include package exposure location forecasting module 306 that may utilize convolutional neural network classification 308 to derive three main package exposures: derived precipitation exposure 310, derived UV exposure 312 and derived temperature exposure 314. In one embodiment, the 3D printed package material selection program 110A, 110B may retrieve visual delivery confirmation corpora 302 using various known art, which enables a system to retrieve photographs or video taken at a delivery location as soon as the delivery provider drops off the package at the location. The 3D printed package material selection program 110A, 110B may also retrieve the delivery destination street view of the delivery location and instruct the package exposure location forecasting module to analyze the information. The 3D printed package material selection program 110A, 110B may then determine the package's expected exposure to three factors. Based on the photographs or the street view information, the convolutional neural network classification 308 may determine whether it is raining or snowing at the delivery location or how strong the sunlight is. The convolutional neural network classification 308 may also monitor the temperature to which the package is expected to be exposed.

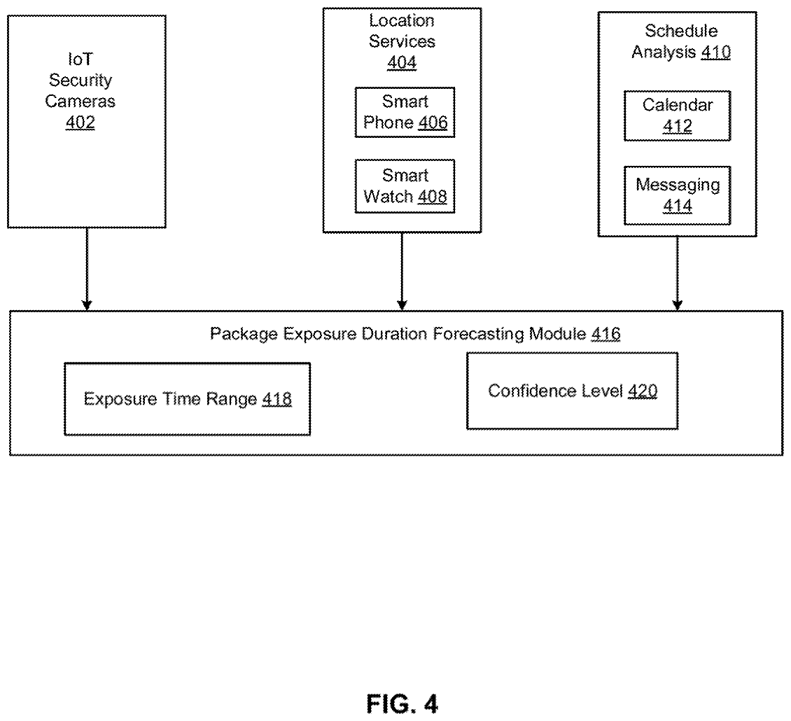

Referring now to FIG. 4, an exemplary diagram showing a package delivery exposure duration deriving process is depicted according to at least one embodiment. According to one embodiment, the 3D printed package material selection program 110A, 110B may include package exposure duration forecasting module 416 which utilize IoT security camera 402, location service 404 and schedule analysis 410 to derive exposure time range 418 and the confidence level 420 of the information that the module received. IoT security camera 402 may be utilized to provide information as to how long a package is staying outdoor or when the recipient brings the package inside the house. The 3D printed package material selection program 110A, 110B may utilize smartphone 406 and smartwatch 408 to retrieve current location information of the recipient. For instance, location services 404 may determine whether the recipient is still at work or is on the way to the recipient's house. The 3D printed package material selection program 110A, 110B may also utilize schedule analysis 410 based on the recipient's calendar 412 and the messaging 414. Electronic schedule information may indicate when a recipient is likely to return home or whether the recipient is out of town for certain days. The above information may be used to forecast for a given expected delivery date and time of a package when the package is forecast to be brought indoors. Confidence level 420 may be determined based on the strength of the information. For example, emails indicating that a recipient is out of town for a few days may be given a higher score than a text message showing less detailed information as to how long the recipient is going to be out of town. The 3D printed package material selection program 110A, 110B may assign a shorter hour range to given forecast exposure time based on a high confidence level (e.g. one hour range), whereas a longer hour range may be assigned to the information with a much lower confidence level (e.g. three to four hours range).

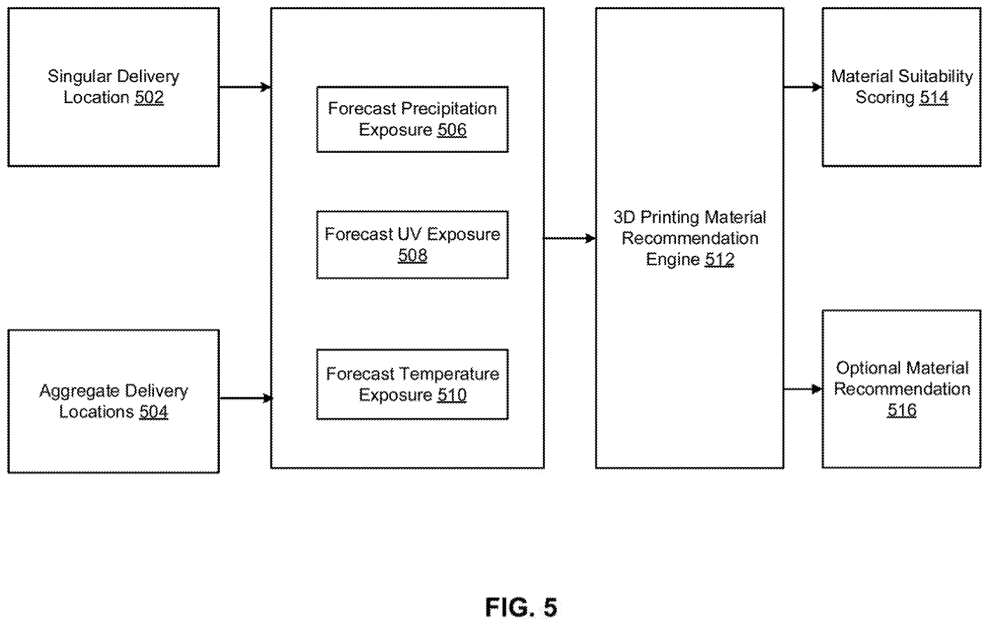

Referring now to FIG. 5, an exemplary diagram showing a 3D printing material suitability scoring and optimal material recommendation process are depicted according to at least one embodiment. According to one embodiment, the 3D printed package material selection program 110A, 110B may include 3D printing material recommendation engine 512 with may receive forecast precipitation exposure 506, forecast UV exposure 508 and forecast temperature exposure 510 to generate material suitability scoring 514 and optional material recommendation 516. The 3D printed package material selection program 110A, 110B may forecast precipitation, UV, and Temperature exposure for both singular delivery location 502 and aggregate delivery locations 504. Aggregate delivery locations 504 may be used for a batch of packages with one or more delivery locations. Material suitability scoring 514 may generate a score for each candidate material from a preconfigured candidate pool of materials. The preconfigured candidate pool of materials may be manually selected based on a user preference. Optional material recommendation 516 may generate a report which includes both summarization of suitability scoring process and recommendation of one or more optimal materials suitable for forecast precipitation exposure 506, forecast UV exposure 508 and forecast temperature exposure 510.

It may be appreciated that FIGS. 2-5 provide only an illustration of one implementation and do not imply any limitations with regard to how different embodiments may be implemented. Many modifications to the depicted environments may be made based on design and implementation requirements. For example, in at least one embodiment, the 3D printed package material selection program 110A, 110B may aggregate derived exposure to precipitation, UV and temperature for multiple delivery locations for a batch of orders and derive which 3D printing material meets the needs of the aggregate of delivery locations. In yet another embodiment, the 3D printed package material selection program 110A, 110B may analyze an expected package transportation method (e.g. truck, ship, airplane, etc.) to derive an optimal packaging material.

FIG. 6 is a block diagram of internal and external components of the client computing device 102 and the server 112 depicted in FIG. 1 in accordance with an embodiment of the present invention. It should be appreciated that FIG. 6 provides only an illustration of one implementation and does not imply any limitations with regard to the environments in which different embodiments may be implemented. Many modifications to the depicted environments may be made based on design and implementation requirements.

The data processing system 602, 604 is representative of any electronic device capable of executing machine-readable program instructions. The data processing system 602, 604 may be representative of a smartphone, a computer system, PDA, or other electronic devices. Examples of computing systems, environments, and/or configurations that may represented by the data processing system 602, 604 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 602 a,b and external components 604 a,b illustrated in FIG. 6. Each of the sets of internal components 602 include one or more processors 620, one or more computer-readable RAMs 622, and one or more computer-readable ROMs 624 on one or more buses 626, and one or more operating systems 628 and one or more computer-readable tangible storage devices 630. The one or more operating systems 628, the software program 108 and the 3D printed package material selection program 110A in the client computing device 102 and the 3D printed package material selection program 110B in the server 112 are stored on one or more of the respective computer-readable tangible storage devices 630 for execution by one or more of the respective processors 620 via one or more of the respective RAMs 622 (which typically include cache memory). In the embodiment illustrated in FIG. 6, each of the computer-readable tangible storage devices 630 is a magnetic disk storage device of an internal hard drive. Alternatively, each of the computer-readable tangible storage devices 630 is a semiconductor storage device such as ROM 624, EPROM, flash memory or any other computer-readable tangible storage device that can store a computer program and digital information.

Each set of internal components 602 a,b also includes an R/W drive or interface 632 to read from and write to one or more portable computer-readable tangible storage devices 638 such as a CD-ROM, DVD, memory stick, magnetic tape, magnetic disk, optical disk or semiconductor storage device. A software program, such as the 3D printed package material selection program 110A, 110B can be stored on one or more of the respective portable computer-readable tangible storage devices 638, read via the respective R/W drive or interface 632 and loaded into the respective hard drive 630.

Each set of internal components 602 a,b also includes network adapters or interfaces 636 such as a TCP/IP adapter cards, wireless Wi-Fi interface cards, or 3G or 4G wireless interface cards or other wired or wireless communication links. The software program 108 and the 3D printed package material selection program 110A in the client computing device 102 and the 3D printed package material selection program 110B in the server 112 can be downloaded to the client computing device 102 and the server 112 from an external computer via a network (for example, the Internet, a local area network or other, wide area network) and respective network adapters or interfaces 636. From the network adapters or interfaces 636, the software program 108 and the 3D printed package material selection program 110A in the client computing device 102 and the 3D printed package material selection program 110B in the server 112 are loaded into the respective hard drive 630. In some embodiments, a 3D printer (not shown) that creates a solid (a 3D object) may be coupled with the network adapters or interfaces 636 via a network. The network may comprise copper wires, optical fibers, wireless transmission, routers, firewalls, switches, gateway computers and/or edge servers.

Each of the sets of external components 604 a,b can include a computer display monitor 644, a keyboard 642, and a computer mouse 634. External components 604 a,b can also include touch screens, virtual keyboards, touch pads, pointing devices, and other human interface devices. In various embodiments, external components 604 a,b can include a 3D printer (not shown) that creates a solid (a 3D object). Each of the sets of internal components 602 a,b also includes device drivers 640 to interface to computer display monitor 644, keyboard 642, and computer mouse 634. The device drivers 640, R/W drive or interface 632, and network adapter or interface 636 comprise hardware and software (stored in storage device 630 and/or ROM 624).

It is understood in advance that although this disclosure includes a detailed description on cloud computing, implementation of the teachings recited herein is not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is a service oriented with a focus on statelessness, low coupling, modularity, and semantic interoperability. At the heart of cloud computing is an infrastructure comprising a network of interconnected nodes.

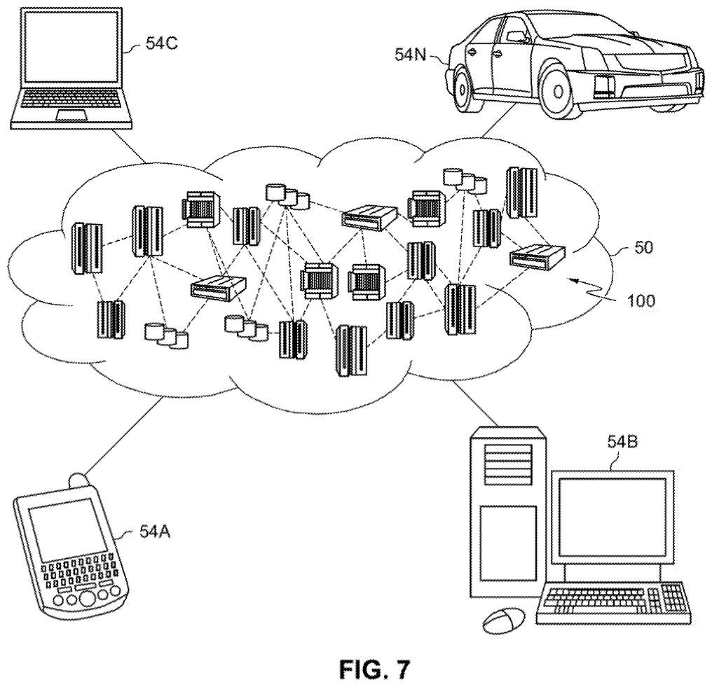

Referring now to FIG. 7, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 100 and cloud computing environment 50 can communicate with any type of computerized device over any type of network and/or network addressable connection (e.g., using a web browser).

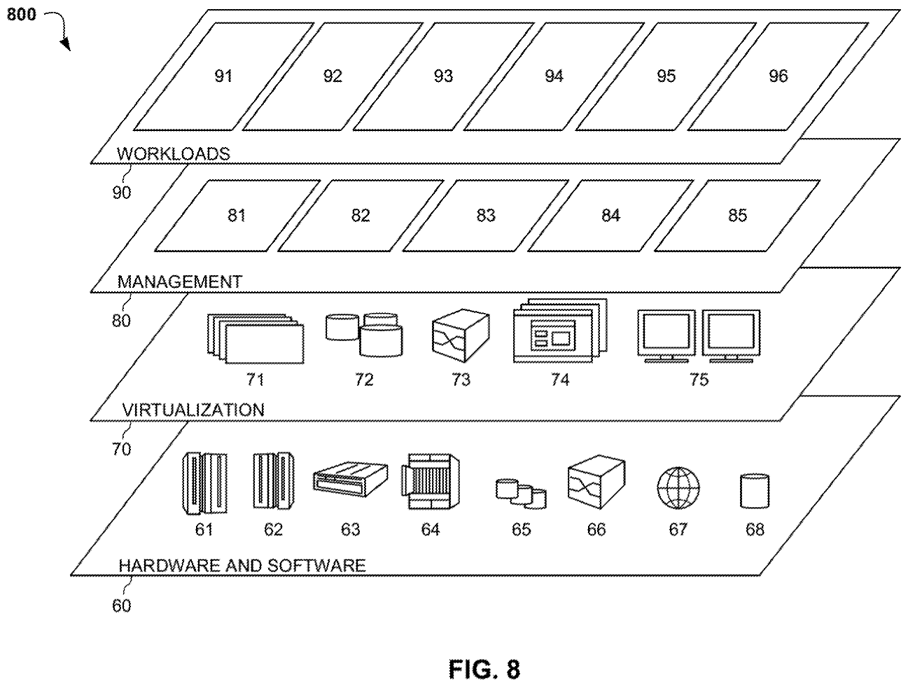

Referring now to FIG. 8, a set of functional abstraction layers 800 provided by cloud computing environment 50 is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and 3D printed package material selection 96. 3D printed package material selection 96 may relate to selection of material to use for 3D printing based on weather forecasts.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for optional material selection for a 3D printed package, the method comprising:
deriving a delivery window of a shipping package from a delivery provider;
deriving an expected package outdoor exposure at a delivery destination;
deriving an expected exposure duration;
retrieving weather forecast for the derived delivery window, the derived package outdoor exposure and the derived exposure duration;
generating a forecast precipitation exposure, a forecast UV exposure and a forecast temperature exposure based on the retrieved weather forecast;
scoring a 3D packaging material suitability for each packaging material; and
generating an optimal material recommendation based on the scoring of the 3D packaging material suitability for each packing material.

2. The method of claim 1, wherein the forecast precipitation exposure, the forecast UV exposure, and the forecast temperature exposure is determined from the time the shipping package is delivered to the delivery destination to the time the shipping package is collected and brought inside from the delivery destination by a recipient of the shipping package.

3. The method of claim 1, wherein the delivery window comprises an expected delivery date and time window.

4. The method of claim 1, wherein the expected package outdoor exposure at the delivery destination is derived using a convolutional neural network visual image classification technique.

5. The method of claim 1, wherein the expected package outdoor exposure at the delivery destination is derived using a visual delivery confirmation corpus and a street view mapping.

6. The method of claim 1, wherein the expected exposure duration is retrieved using an IoT security camera that shows how long the package remains outdoor.

7. The method of claim 1, wherein the expected exposure duration is retrieved using mobile devices that comprise smartphone and smartwatch.

8. The method of claim 1, wherein the expected exposure duration is retrieved based on a recipient's electronic schedule information.

9. The method of claim 1, further comprising:
computing confidence level of information related to the expected exposure duration; and
calculating a time range for the expected exposure duration.

10. The method of claim 1, wherein each of the packaging material is selected from a candidate material pool that is preconfigured by a processor, or manually selected by the delivery provider or a recipient of the package.

11. The method of claim 1, further comprising:
generating an aggregate optima packaging material recommendation for a batch of packages for all delivery locations.

12. A computer system for optional material selection for a 3D printed package, the computer system comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
deriving a delivery window of a shipping package from a delivery provider;
deriving an expected package outdoor exposure at a delivery destination;
deriving an expected exposure duration;
retrieving weather forecast for the derived delivery window, the derived package outdoor exposure and the derived exposure duration;
generating a forecast precipitation exposure, a forecast UV exposure and a forecast temperature exposure based on the retrieved weather forecast;
scoring a 3D packaging material suitability for each packaging material; and
generating an optimal material recommendation based on the scoring of the 3D packaging material suitability for each packing material.

13. The computer system of claim 12, wherein the forecast precipitation exposure, the forecast UV exposure, and the forecast temperature exposure is determined from the time the shipping package is delivered to the delivery destination to the time the shipping package is collected and brought inside from the delivery destination by a recipient of the shipping package.

14. The computer system of claim 12, wherein the delivery window comprises an expected delivery date and time window.

15. The computer system of claim 12, wherein the expected package outdoor exposure at the delivery destination is derived using a convolutional neural network visual image classification technique.

16. The computer system of claim 12, wherein the expected package outdoor exposure at the delivery destination is derived using a visual delivery confirmation corpus and a street view mapping.

17. The computer system of claim 12, wherein the expected exposure duration is retrieved using an IoT security camera that shows how long the package remains outdoor.

18. The computer system of claim 12, wherein the expected exposure duration is retrieved using mobile devices that comprise smartphone and smartwatch.

19. The computer system of claim 12, wherein the expected exposure duration is retrieved based on a recipient's electronic schedule information.

20. A computer program product for optional material selection for a 3D printed package, the computer program product comprising:
one or more computer-readable tangible storage media and program instructions stored on at least one of the one or more tangible storage media, the program instructions executable by a processor of a computer to perform a method, the method comprising:
deriving a delivery window of a shipping package from a delivery provider;
deriving an expected package outdoor exposure at a delivery destination;
deriving an expected exposure duration;
retrieving weather forecast for the derived delivery window, the derived package outdoor exposure and the derived exposure duration;
generating a forecast precipitation exposure, a forecast UV exposure and a forecast temperature exposure based on the retrieved weather forecast;
scoring a 3D packaging material suitability for each packaging material; and
generating an optimal material recommendation based on the scoring of the 3D packaging material suitability for each packing material.
